(19) United States
(12) Patent Application Publication
(10) Pub. No.: US 2026/0226313 A1
(43) Pub. Date: Aug. 6, 2026

(54) METHOD FOR TREATING THE SURFACE OF GLASS

(71) Applicants: Evonik Operations GmbH, Essen (DE); TotalEnergies OneTech SAS, Solaize Cedex (FR)

(72) Inventors: Philipp ALBERT, Lörrach (DE); Eckhard JUST, Rheinfelden (DE); Jacob SHEVRIN, Port Washington, NY (US); Thomas STRUPPERT, Grossheirath (DE); Dave TOWNSEND, Manasquan, NJ (US); Hans-Joachim BREUER, Niederkassel (DE)

(73) Assignees: Evonik Operations GmbH, Essen (DE); TotalEnergies OneTech SAS, Solaize Cedex (FR)

(21) Appl. No.: 19/118,217

(22) PCT Filed: Oct. 6, 2023
(86) PCT No.: PCT/EP2023/077705

§ 371 Date: Apr. 3, 2025

(30) Foreign Application Priority Data
Oct. 10, 2022 (EP) 22200458

(51) Int. Cl. C09D 183/14; C03C 17/30; C09D 7/65

(52) U.S. Cl. CPC C09D 183/14; C03C 17/30; C09D 7/65

(57) ABSTRACT

The present invention concerns a method for treating the surface of glass, a substrate comprising a glass surface treating with the inventive method and the use of the substrate.

The present invention relates to a method for treating at least one glass surface, preferably the surface of a glass container such as a glass bottle, a substrate treated with the method according to the invention and its use.

### BACKGROUND OF THE INVENTION

Glass derives its strength and optical properties from an unblemished surface, and any surficial damage such as scratches or flaws present on its surface considerably reduce its (basic) strength and in particular its compressive strength. Further, the internal burst strength (also referred to as internal pressure resistance) of glass containers such as bottles may be diminished by surficial damages. This poses a severe risk to anyone using such damaged bottles, especially if they contain carbonated beverages because such bottles might burst. Such scratches and flaws are often caused by normal handling of glass, e.g. of glass bottles containing beverages when used or shipped. Surficial damages of glass—particularly when used for decorative purposes—also are an optical deficit when usually clear and smooth glass surfaces are desired. Examples of products where surficial damages are usually not tolerated by the consumers are mirrors, window glass and decorative glass objects.

To avoid the occurrence of scratches and the loss of strength, glass is often subjected to a surface treatment. This surface treatment protects the glass surface of surficial damages. Commonly, tin salts are applied to the glass surface at a temperature of about 500° C. to form a thin tin oxide layer followed by a layer comprising a gliding agent (also referred to as lubricating agent in the art) such as wax at a significantly lower temperature in order to reduce the frailty of glass surfaces towards defects from handling. The tin oxide is necessary to provide a sufficient adhesion of the gliding agent onto the glass surface. Tin salts often are ecologically problematic and harmful to humans. Organic tin compounds are thus under regulatory pressure and monobutyltin trichloride—one of the most frequent used tin compounds for coating glass bottles—is to be phased out in Europe (CoRAP list ECHA) for this application. However, tin compounds are still used because there is no acceptable alternative available even though various alternatives have been considered without reaching the same protection properties.

Various silanes and siloxanes have been proposed as alternatives to tin salts. These systems use mainly epoxy- and aminofunctional silanes and siloxanes.

AU 715826 B2 (Australian application 199731796) teaches the use of monoaminosilanes and gliding agents such as polyolefins on glass ware to impart the surface a certain abrasion resistance.

U.S. Pat. No. 6,096,394 B1 discloses the use of organopolysiloxanes in the cold end coating of glass ware.

JP 2004-196563 describes the application of a formulation containing silanes and polymer dispersions. The silanes are mono silyl-silanes or (triethoxysilylproply)tetrasulfid. In the latter case, the odor of the sulfur silane is not acceptable for an application on glass bottles, especially for one containing beverages.

However, still to date, the prior art coatings using silanes or compounds derived therefrom lack scratch resistance (i.e. dry and wet scratch resistance) and in particular wet scratch resistance. Further, many silane-based systems suffer from poor stability of the treatment solutions containing these compounds requiring frequent replacements of such treatment solutions. This is environmentally and economically undesirous. Because of these disadvantages, they have not been introduced into the industry, especially not into large-scale applications.

### OBJECTIVE OF THE INVENTION

It is therefore the objective of the present invention to overcome the shortcomings of the prior art. It is a further objective of the present invention to provide a method which allows for a sufficiently high scratch resistance of the treated glass surfaces without the use of ecologically harmful tin compounds.

It is of further interest that the optical appearance of glass treated does not become impaired, neither by the treatment itself nor by damages caused by conventional handling. Further, the adherence of labels attached to the treated glass surface has to be acceptable.

### SUMMARY OF THE INVENTION

These objectives are solved by the method for treating at least one glass surface according to the invention, said method comprising the method steps:
a) providing a substrate comprising the at least one glass surface;
b) treating the at least one glass surface with a silane formulation comprising at least one bis-silyl compound comprising at least one building block according to formula (A)

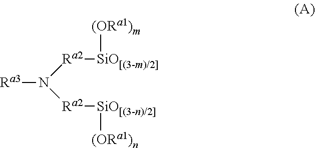

wherein
each R^{a1} is independently selected from the group consisting of hydrogen, alkyl group, polyether group and aryl group,
each R^{a2} is independently an alkanediyl group,
R^{a3} is selected from the group consisting of hydrogen, alkyl group and aryl group,
m is an integer ranging from 0 to 3,
n is an integer ranging from 0 to 3; and
c) treating the at least one glass surface with an additive formulation comprising at least one gliding agent selected from the group consisting of wax, fatty acid and fatty acid ester; such that the at least one treated glass surface is obtained.

Advantageously, the silane formulation used in the method according to the invention is very stable and can be used and stored for a sufficiently long period of time. The present invention is ecologically friendly as no tin compounds are required anymore.

The method according to the invention advantageously reduces the number of scratches on the at least one glass surfaces and thereby, the loss of (basic) strength and internal pressure resistance can be reduced during use and handling of substrates, especially of hollow containers such as bottles.

Preferred embodiments solving above described objectives particularly well are described in the following description and in the dependent claims.

### DETAILED DESCRIPTION OF THE INVENTION

Percentages throughout this specification are weight-percentages (wt.-%) unless stated otherwise. Yields are given as percentage of the theoretical yield. Concentrations given in this specification refer to the mass of the entire solutions or dispersions unless stated otherwise.

The term “alkyl” according to the present invention comprises branched or unbranched alkyl groups comprising cyclic and/or non-cyclic structural elements, wherein cyclic structural elements of the alkyl groups naturally require at least three carbon atoms. C1-CX-alkyl in this specification and in the claims refers to alkyl groups having 1 to X carbon atoms (X being an integer). C1-C18-alkyl for example includes, among others, methyl, ethyl, n-propyl, iso-propyl, n-butyl, isobutyl, sec-butyl, tert-butyl, n-pentyl, iso-pentyl, sec-pentyl, tert-pentyl, neo-pentyl, hexyl, heptyl and octyl, hexadecyl and octadecyl. The alkyl group is typically not substituted unless specified differently hereinafter.

The term “alkanediyl” is the corresponding group having two free valences (bonding sites). Sometimes, it is referred to as “alkylene” in the art. Said residues according to the present invention comprise cyclic and/or non-cyclic structural elements and can be linear and/or branched. C1-C4-alkanediyl for example includes, among others, methane-1,1-diyl, ethane-1,2-diyl, ethane-1,1-diyl, propane-1,3-diyl, propane-1,2-diyl, propane-1,1-diyl, butane-1,4-diyl, butane-1,3-diyl, butane-1,2-diyl, butane-1,1-diyl, butane-2,3-diyl. Usually, unless specified differently hereinafter, the alkanediyl group in not substituted.

The “alkenyl” is an unsaturated alkyl group comprising at least one olefinic (i.e. a C═C-double) bond. Above-described details and preferences for the alkyl groups apply for alkenyl groups mutatis mutandis.

The term “aryl” according to the invention refers to ring-shaped aromatic hydrocarbon residues, for example phenyl or naphthyl. The aryl group is typically not substituted unless specified differently hereinafter.

The term “alkaryl” according to the invention refers to hydrocarbon groups comprising at least one aryl and at least one alkyl group such as benzyl and p-tolyl. The bonding of such an alkaryl group to other moieties may occur via the alkyl or the aryl group of the alkaryl group. Above-described details and preferences for the alkyl and aryl groups apply for alkaryl groups mutatis mutandis.

If more than one residue—being it an atom, a group of atoms or entire building blocks—is to be selected from a given group, each of the residues is selected independently from each other unless stated otherwise hereinafter, meaning they can be selected to be the same members or different members of said group. The bonding sites in some chemical formulae herein may be emphasized by a wavy line (“ [symbol] ”) as it is customary in the art.

Embodiments and preferences described for one aspect of the present invention apply mutatis mutandis for all the other aspects thereof unless technically unfeasible or stated otherwise. The repetition is omitted to improve the conciseness of the specification.

The inventive method comprises method steps a), b) and c). These method steps are usually carried out in the given order. The inventive method optionally comprises further method steps to be carried out before, after and/or between said method steps. Method steps b) and c) may be carried out simultaneously, e.g., the silane formulation and the additive formulation can be sprayed onto the glass surface from two different spray devices at the same time. However, it is preferred to conduct the method steps in the given order to achieve optimal results.

In method step a) of the inventive method, a substrate comprising the at least one glass surface is provided. The substrate is not particularly limited in its form or function as long as it comprises the at least one glass surface. Optionally, the substrate is made in its entirety out of glass. In one embodiment of the present invention, the substrate consists of the at least one glass surface.

The substrate comprising the at least one glass surface is preferably a hollow container, more preferably selected from the group consisting of bottle, thermos, ampule, tube, jar, vial and flask. The substrate is optionally made of glass in its entirety.

Glass in the context of the present invention is not particularly limited. Glass includes soda lime silicate glass, alumosilicate glass, borosilicate glass, alumoborosilicate glass, silica glass, and the like but also, albeit not preferred, non-silicated glass.

Optionally, the method comprises a further method step after method step a) and before method step b):
a.i) cleaning the at least one glass surface.

There is a multitude of methods available to the person skilled in the art aiming inter alia at removing dirt and grease therefrom. For example, the at least one glass surface can be cleaned chemically. Chemical cleaning includes inter alia treating said surface with an (alkaline) aqueous solution comprising a suitable surfactant and/or oxidant. Alternatively, it can be wiped with a cloth, said cloth optionally containing aforementioned aqueous solution.

In method step b) of the method according to the invention, the at least one glass surface is treated with the silane formulation. The at least one glass surface is treated entirely or only one or more parts thereof are treated with said silane formulation. As noted hereinbefore, the silane formulation comprises the at least one bis-silyl compound.

The silane formulation comprises the at least one bis-silyl compound comprising at least one building block according to formula (A) (said compound will be hereinafter referred to as “bis-silyl compound”). The bis-silyl compound is known in the art and commercially available or can be prepared by known methods.

A polyether group is preferably a —[CH₂—CH(R′)—O]; —R″ group wherein R′ is selected from the group consisting of hydrogen and methyl group, R″ is selected from the group consisting of hydrogen, alkyl group and aryl group and j is an integer ranging from 1 or 3 to 100, more preferably from 5 to 20.

R^{a1} is preferably selected from the group consisting of hydrogen and C1-C4-alkyl group. More preferably, R^{a1} is hydrogen. R^{a2} is preferably a C1-C8-alkanediyl group, more preferably a C2-C4-alkandiyl group, even more preferably a 1,3-propanediyl group. R^{a3} is preferably selected from the group consisting of hydrogen and C1-C4-alkyl group. More preferably, R^{a3} is hydrogen.

It is particularly preferred that R^{a1} is selected from the group consisting of hydrogen and C1-C4-alkyl group (more preferably each R^{a1} is hydrogen), R^{a2} is a C2-C4-alkandiyl group (each R^{a2} is more preferably a 1,3-propanediyl group) and R^{a3} is selected from the group consisting of hydrogen and C1-C4-alkyl group (each R^{a3} is more preferably hydrogen). This particular preferred selection for the at least one building block according to formula (A) is referred to as particular preferred selection A1. It is even more preferred that R^{a1} is hydrogen, R^{a2} is 1,3-propanediyl group and R^{a3} is hydrogen. This particular preferred selection for the at least one building block according to formula (A) is referred to as particular preferred selection A2.

m is preferably selected from 0, 1 and 2. n is preferably selected from 0, 1 and 2. Preferably, at least one of m and n is less than 3.

Preferably, the bis-silyl compound comprises (in addition to the at least one building block according to formula (A)) at least one building block according to formula (B)

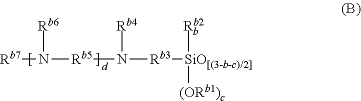

wherein
each R^{b1} is independently selected from the group consisting of hydrogen, alkyl group and aryl group,
R^{b2} is an alkyl group,
R^{b3} is an alkanediyl group,
R^{b4} is selected from the group consisting of hydrogen, alkyl group, aryl group and alkaryl group,
each R^{b5} is independently an alkanediyl group,
R^{b6} is selected from the group consisting of hydrogen, alkyl group, aryl group and alkaryl group,
R^{b7} is selected from the group consisting of hydrogen and alkyl group,
b is selected from 0 and 1,
c is selected from 0, 1 and 2,
d is selected from 0, 1 and 2,
with the proviso that the sum of b and c ranges from 0 to 2.

Said additional building blocks according to formula (B) in the bis-silyl compound advantageously further improves the wet scratch resistance of the treated glass surface with the silane formulation (see examples).

In case the bis-silyl compound comprises the at least one building block according to formula (B), at least one of m and n is less than 3.

Preferably, R^{b}, is preferably selected from the group consisting of hydrogen and C1-C4-alkyl group.

More preferably, R^{b}, is hydrogen.

R^{b2} is preferably a C1-C4-alkyl group, R^{b2} is more preferably a methyl group.

R^{b3} is preferably a C1-C8-alkanediyl group, more preferably a C2-C4-alkandiyl group, even more preferably 1,3-propanediyl.

R^{b4} is preferably selected from the group consisting of hydrogen, alkyl group and aryl group, more preferably from hydrogen and C1-C4-alkyl group, R^{b4} is even more preferably hydrogen.

Preferably, R^{b}s is a C1-C8-alkanediyl group, more preferably a C2-C4-alkanediyl group, even more preferably a 1,2-ethanediyl group.

R^{b6} is preferably selected from the group consisting of hydrogen, alkyl group and aryl group, more preferably from hydrogen and C1-C4-alkyl group, R^{b6} is even more preferably hydrogen.

R^{b7} is preferably selected from the group consisting of hydrogen, alkyl group and aryl group, more preferably from hydrogen and C1-C4-alkyl group, R^{b7} is even more preferably hydrogen. It is still even more preferred that R^{b4}, R^{b6} and R^{b7} are hydrogen.

b is preferably 0. c is preferably selected from 0 and 1. d is preferably 0.

A particular preferred embodiment of the at least one building block according to formula (B) is the building block according to formula (B1)

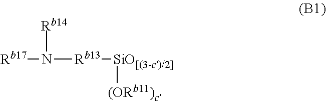

wherein
each R^{b11} is independently selected from the group consisting of hydrogen and C1-C4-alkyl group,
R^{b13} is a C2-C4-alkandiyl group, even more preferably 1,3-propanediyl,
R^{b14} is selected from the group consisting of hydrogen and C1-C4-alkyl group, R^{b14} is even more preferably hydrogen,
R^{b17} is selected from the group consisting of hydrogen and C1-C4-alkyl group, R^{b17} is even more preferably hydrogen, and
c′ is selected from 0, 1 and 2. Preference is given to all of R^{b11}, R^{b14} and R^{b17} being hydrogen.

The building block according to formula (B1) is the preferred alternative of the aforementioned building block according to formula (B). It is preferably used as the sole alternative of the latter or (less preferred) both building blocks are used in combination. It is preferred that the at least one bis-silyl compound comprises (or consists) of at least one building block according to formula (A) employing the aforementioned particular preferred selection A1 and the at least one building block according to formula (B1) because very good results can be obtained. It is more preferred that the at least one bis-silyl compound comprises (or consists) of at least one building block according to formula (A) employing the aforementioned particular preferred selection A2 and the at least one building block according to formula (B1) because optimal results can be obtained.

The total number of building blocks according to formula (A) and—if present—of building blocks according to formula (B) in the bis-silyl compound preferably ranges from 2 to 1000, more preferably from 3 to 500, even more preferably from 4 to 100, yet even more preferably from 5 to 50.

Preferably, the numerical ratio of the building blocks according to formula (A) and the building blocks according to formula (B) in the bis-silyl compound ranges from 1 (building block according to formula (A)) to 0.1-1000 (building blocks according to formula (B)), more preferably 1 to 1-250, even more preferably 1 to 1-50, still even more preferably 1 to 1-10, resulting in optimal wet scratch resistances of such treated glass surfaces over a wide range of concentrations of the bis-silyl compound present in the silane formulation. The number or ratio of building blocks can be determined by standard means, e.g. ¹H, ¹³C, and/or ²⁹Si-NMR spectroscopy. The person skilled in the art is aware of further suitable methods such as gel permeation chromatography.

The at least one building block according to formula (A) and—if contained in the bis-silyl compound—the at least one building block according to formula (B) preferably make up for at least 50 weight-%, more preferably 75 weight-%, even more preferably 90 weight-%, of the bis-silyl compound. The bis-silyl compound most preferably consists of the one or more building blocks according to formula (A) and optionally, the one or more building blocks according to formula (B).

Preferably, the at least one bis-silyl compound is an oligomer or a polymer as an improved crosslinking density of the film obtained from the bis-silyl compound can then be obtained. The improved crosslinking density results in an enhanced dry and wet scratch resistance of the treated surface. An oligomer according to the invention comprises (in total) 2 to 4 building blocks according to formulae (A) and (optionally) (B), a polymer comprises (in total) at least 5 building blocks according to formulae (A) and (optionally) (B). A non-limiting example of an oligomer comprising one building block according to formula (A) and (B) is depicted hereinafter:

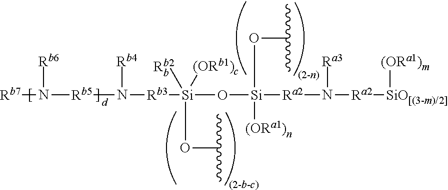

Oligomers and polymers usually comprise one or more of linear, branched and cyclic structures (said structures being formed by the building blocks according to formula (A) and/or (B)). The building blocks described herein can also be understood as structural repeating units if more than one building block according to formula (A) and optionally (B) is comprised by the bis-silyl compound. The building blocks contained in the at least one bis-silyl compound, i.e. the building blocks according to formulae (A) and—if present—(B), can be arranged in various patterns if the at least one bis-silyl compound is an oligomer or a polymer. The patterns formed by the building blocks can comprise alternating, block and/or random patterns. If more than one building block according to formulae (A) and optionally (B) is comprised by the bis-silyl compound, they are typically bound to each other by a joint oxygen atom between the silicon atoms of the respective building blocks (depicted in the chemical formulae as O_{y/2} where y represents one of (3-m), (3-n), (3-b-c) or (3-c′)).

As used conventionally in the art, the R_{g}—SiO_{(4-g/2)} shall be understood that the depicted silicon atom carries 4-g oxygen atoms (g being an integer ranging from 0 to 4) and g residues R. The oxygen atoms are bound by a single bond to the silicon atom and thus have another substituent such as a silicon atom of a unity named above. In the case of the present invention, the other silicon atom is preferably one of a building block according to formula (A) or (B). If g is 3, a M-unit is present. If g is 2, a D-unit is present. If g is 1, a T-unit is present. If g is 0, a Q-unit is present. This nomenclature is known to the person skilled in the art, e.g. from W. Noll, Chemie und Technologie der Silicone, Verlag Chemie, Weinheim Bergstr., 1960, p. 2 et seqq.

An alternative representation of the building block according to formula (A) is:

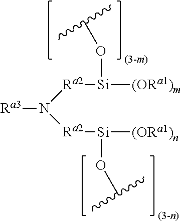

This alternative representation of the building block according to formula (A) highlights the bridging function of the oxygen atoms bound to the silicon atoms that are enumerated as “O_{(3-h/2)}” (where h represents m or n) in the above depiction. The free valences of these oxygen atoms (shown with bonds to wavy lines) can be satisfied with any suitable partners, preferably silicon atoms of other building block according to formulae (A) or (B). If the free valences are satisfied with silicon atoms of other building block according to formulae (A) and/or (B), then the bis-silyl compound is an oligomer or a polymer.

Similarly, an alternative representation of the building block according to formula (B) can be depicted as follows:

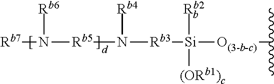

An exemplary oligomer of the bis-silyl compound consisting of 3 building block according to formula (A) is depicted in the following. In this depiction, the three building blocks are highlighted by rectangular boxes with dashed lines to further illustrate the concept of building blocks. The building blocks are joined by bridging oxygen atoms.

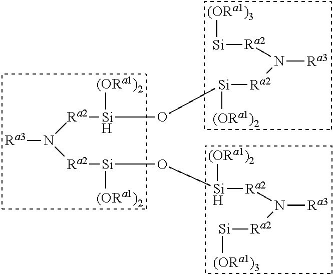

As known in the art, the bis-silyl compound can be prepared by reacting bis-(trialkoxysilylpropyl)amine and optionally one or more aminofunctional silanes such as AMEO and allowing them to condense. By said condensation of the aforementioned silanes, alkoxy groups are cleaved in favor of the formation of siloxane bonds (“Si—O—Si”) that are depicted above. These siloxane bond comprise the bridging oxygen atom placed between two silicon atoms of the respective building blocks.

The amount of the at least one bis-silyl compound in the silane formulation preferably ranges from 0.001 to 10 weight-%, more preferably from 0.01 to 4 weight-%, even more preferably from 0.05 to 1 weight-%, still even more preferably from 0.1 to 0.8 weight-%, based on the total silane formulation. If more than one bis-silyl compound is comprised in the silane formulation, the amount of all bis-silyl compounds preferably lies in above-defined ranges.

The silane formulation preferably comprises at least one acid. The at least one acid advantageously improves the stability of the silane formulation. Acids are typically Brønsted acids having a pKₐ value sufficiently high to transfer a proton onto another component in the silane formulation. The at least one acid is typically selected from inorganic acids and organic acids. Preferred inorganic acids are selected from the group consisting of nitric acid, hydrochloric acid, methanesulfonic acid and mixtures of the aforementioned.

Organic acids are preferred and preferably selected from the group consisting of monocarboxylic acids and dicarboxylic acids. Said acids are preferably unsubstituted. Monocarboxylic acids are more preferred as the at least one acid because they surprisingly improve the wetting of the glass surface of the substrate and therefore, improve the beneficial effects of the present invention. Even more preferably, the at least one acid is a monocarboxylic acid having one to four carbon atoms, the at least one acid is still even more preferably selected from acetic acid and formic acid. Most preferred is formic acid in this context as it excels in this regard.

The amount of the at least one acid depends inter alia on the amine number of the bis-silane compound. Typically, the amount of the at least one acid ranges from 0.00001 to 10 weight-%, preferably from 0.01 to 1 weight-%, more preferably from 0.2 to 0.1 weight-%, based on the total silane formulation.

The silane formulation preferably comprises water, preferably in an amount of 1 to 99.9 weight-%, more preferably 5 to 90 weight-%, even more preferably 10 to 80 weight-%, based on the total silane formulation.

The silane formulation optionally comprises at least one organic solvent. Any organic solvent suitable to dissolve or disperse the components of the silane formulation can be employed. The at least one organic solvent is preferably a polar solvent, more preferably an alkanol, even more preferably a C1-C4-alkanol. The one or more optional organic solvents is preferably contained in a total amount of 25 weight-% or less, more preferably in an amount of 20 weight-% or less, even more preferably in an amount of 15 weight-% or less, yet even more preferably 1.0 weight-% or less, based on the total silane formulation. Ideally, the amount thereof is less than 0.1 weight-% as this further improves the ecological effects of the present invention.

Ideally, the silane formulation is a solution, preference given to an aqueous solution, facilitating treatment of the at least one glass surface therewith, in particular if the silane formulation is applied by spraying due to the avoidance of clogging of the nozzles of the spray application device. Alternatively, the silane formulation is a dispersion, preferably a microemulsion. In the latter cases, the silane formulation comprises at least one emulsifier. The at least one emulsifier and its amount can be selected based on the general knowledge of the person skilled in the art and routine experiments. Useful emulsifiers in this case can be selected from those described for the additive formulation (vide infra).

The pH value of the silane formulation usually ranges from 1 to 14. The pH value preferably ranges from 2 to 7, more preferably from 3 to 5 resulting in an improved stability of the silane formulation.

The solids content of the silane formulation preferably ranges from 0.01 to 15%, more preferably from 0.05 to 10%, even more preferably from 0.1 to 1%.

The viscosity of the silane formulation preferably ranges from 0.1 to 100000 mPas, more preferably from 0.5 to 100 mPas, even more preferably from 1 to 5 mPas. Silane formulations having viscosities in above ranges can easily be applied, especially by spray applications without the risk of clogging the nozzles of the spray application device.

The silane formulation can be prepared by standard and known means in the art. Exemplarily, the components described hereinbefore can be mixed in a suitable vessel employing standard means. The at least one bis-silyl compound is known in the art and is commercially available. For example, an oligomeric or polymeric bis-silyl compound can be prepared by hydrolysis and condensation of bis-(trialkoxysilylpropyl)amine and optionally one or more aminofunctional silanes such as AMEO. The alcohol obtained during the preparation is preferably removed by distillation.

It is preferred that the silane formulation—in addition to the at least one bis-silyl compound—comprises at least one silane-based compound comprising at least one building block according to formula (I)

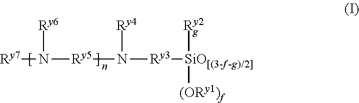

wherein
   each R^{y1} is independently selected from the group consisting of hydrogen, alkyl group, polyether group and aryl group,
   R^{y2} is an alkyl group,
   R^{y3} is an alkanediyl group,
   R^{y4} is selected from the group consisting of hydrogen, alkyl group, aryl group and alkaryl group,
   each R^{y5} is independently an alkanediyl group,
   R^{y6} is selected from the group consisting of hydrogen, alkyl group, aryl group and alkaryl group,
   R^{y7} is selected from the group consisting of hydrogen and alkyl group,
   f is selected from 0, 1 and 2
   g is selected from 0 and 1,
   h is selected from 0, 1 and 2,
with the proviso that the sum of f and g preferably ranges from 0 to 2.

The silane-based compound further improves the wet scratch resistance. It is preferred that the silane-based compound is contained in the silane formulation in particular if the at least one bis-silyl compound comprises or consists of building block according to formula (A) only. The silane-based compound preferably does not comprise any building blocks according to formula (A).

R^{y1} is preferably selected from the group consisting of hydrogen and C1-C4-alkyl group.

R^{y3} is preferably a C2-C4-alkandiyl group.

R^{y4} is preferably selected from the group consisting of hydrogen and C1-C4-alkyl group.

R^{y7} is preferably selected from the group consisting of hydrogen and C1-C4-alkyl group.

g is preferably 0. h is preferably 0.

In a preferred embodiment of the present invention, R^{y1} is selected from the group consisting of hydrogen and C1-C4-alkyl group;
R^{y3} is a C2-C4-alkandiyl group;
R^{y4} is selected from the group consisting of hydrogen and C1-C4-alkyl group;
R^{y7} is selected from the group consisting of hydrogen and C1-C4-alkyl group;
g is 0; f is selected from 0, 1 and 2; and h is 0.

The at least one building block according to formula (I) preferably makes up for at least 50 weight-%, more preferably 75 weight-%, even more preferably 90 weight-%, of the silane-based compound. The silane-based compound most preferably consists of the one or more building blocks according to formula (I). The number or ratio of building blocks can be determined by standard means, e.g. ¹H, ¹³C, and/or ²⁹Si-NMR spectroscopy. The person skilled in the art is aware of further suitable methods such as gel permeation chromatography.

In the silane formulation, the amount of the silane-based compound preferably ranges from 0.001 to 20 weight-%, more preferably from 0.01 to 8 weight-%, even more preferably from 0.05 to 2 weight-%, yet even more preferably from 0.1 to 1.6 weight-%, based on the total silane formulation.

The silane-based compound is known in the art and commercially available. A useful preparation method is inter alia described in US 2018/127442 A1 (in particular paragraphs 11 to 41 and the examples 1, 2 and 3).

The at least one silane-based compound is preferably an oligomer or a polymer for the same reasons outlined for the at least one bis-silyl compound. The details described for the building block patterns described for the at least one bis-silyl compound apply mutatis mutandis for the at least one silane-based compound.

The weight ratio of the at least one silane-based compound and the at least one bis-silyl compound—if the first-mentioned compound is present in the silane formulation according to the invention—preferably ranges from 0.1 to 0.9, more preferably 0.2 to 0.8, even more preferably from 0.3 to 0.7.

In one embodiment of the present invention, the silane formulation comprises or consists of:
the at least one bis-silyl compound;
the at least one acid,
water,
optionally, the at least one organic solvent,

preferably in amounts given hereinbefore. In this embodiment, preferences outlined hereinbefore apply mutatis mutandis.

In a preferred embodiment of the present invention, the silane formulation comprises or consists of:
the at least one bis-silyl compound;
the at least one acid,
water,
the at least one silane-based compound,
optionally, the at least one organic solvent,

preferably in amounts given hereinbefore. In this embodiment, preferences outlined hereinbefore apply mutatis mutandis.

The temperature of the at least one glass surface in method steps b) preferably ranges from 20 to 200° C., more preferably from 60 to 150° C., even more preferably from 100 or 110 to 130° C. The glass surface thus does not require to be heated to an as high temperature as in the case of the commonly used tin compounds. The method according to the invention therefore saves energy and is more environmentally benign.

Optionally, the temperature of the silane formulation is adjusted to a value ranging from 10 to 80° C., preferably 20 to 30° C., prior to it being used for the treating the at least one glass surface therewith.

In general, it is advisable to keep the temperature difference between the silane formulation (or the additive formulation in method step c)) and the glass surface in certain ranges. For example, a temperature difference between the additive formulation and the glass surface of 100° C. or above should be avoided. Otherwise, the glass surface may suffer from the treatment resulting in breakages or the like. Temperature differences that may be tolerated depend in particular on the type of glass used. The person skilled in the art is aware of this and select suitable temperatures based on his general knowledge or based on routine experiments.

In method step c), the at least one glass surface is treated with the additive formulation. The additive formulation comprises the at least one gliding agent. Gliding agents useful for this purpose are known in the art and can be selected based on routine experiments by the person skilled in the art. The at least one gliding agent is preferably selected from the group consisting of wax, fatty acid and fatty acid ester. More preferably, the at least one gliding agent is selected from the group consisting of wax, fatty acid and fatty acid ester. Even more preferably, the at least one gliding agent is a wax. The outlined preferences allow for an increasing scratch resistance.

The wax is preferably used as an aqueous dispersion. In general, any wax which is dispersible in water can be used in the present invention. The wax is preferably selected from natural waxes and synthetic waxes. Natural waxes include recent waxes such as beeswax, carnauba wax or candelilla wax, fossil waxes such as montan wax or derivatives thereof and petroleum waxes (both paraffin waxes and microwaxes). Generally, in case the additive formulation is a dispersion (e.g. an emulsion), it preferably comprises at least one emulsifier to be selected by the person skilled in the art in routine experiments or based on his general knowledge (vide infra).

Synthetic waxes are preferably selected from the group consisting of Fischer-Tropsch waxes, polyolefin waxes (such as polyethylene wax, polypropylene wax, polyisobutylene wax and copolymers thereof), amide waxes (e.g. N,N′-distearoylethylenediamine), polyethylene glycol wax and polypropylene glycol wax. More preferably, the synthetic wax is a polyolefin wax or a copolymer thereof, even more preferably a polyolefin wax, still even more preferably a polyethylene wax.

In one embodiment of the present invention, the at least one gliding agent is a wax, preferably the at least one gliding agent is selected from the group consisting of amide wax, polyolefin wax and a copolymer of a polyolefin wax, more preferably the at least one gliding agent is a polyolefin wax or a copolymer thereof, even more preferably a polyolefin wax, still even more preferably a polyethylene wax.

Non-polar waxes such as petroleum waxes, Fischer-Tropsch waxes and polyolefin waxes are preferably, in the interests of better dispersibility, used in their oxidized form. Such oxidized waxes have been known for a long time.

For the purposes of the invention, particular preference is given to polyethylene waxes (also occasionally referred to as “polyethylene” in the art). The polyethylene wax used generally has a number average molecular weight (Mn) in the range from 400 to 20,000 g/mol (as measured by GPC, PLgel column (Agilent), solvent: 1,2,4-trichlorobenzene+0.015 wt % butylated hydroxytoluene, 160° C., using polyethylene standards provided by Agilent). Preferably, the Mn is in the range from 500 to 15,000 g/mol and more preferably from 1000 to 8000 g/mol. Said ranges result in improved stabilities of the additive formulation and enhanced scratch resistances.

It is preferred that the melting point of the polyethylene wax ranges from 50 to 170° C., preferably from 80 to 150° C., more preferably from 100 to 135° C. The melting point is measured in according with DIN 51532 (2012). Said ranges result in improved stabilities of the additive formulation and enhanced scratch resistances.

There are plenty of methods known to the person skilled in the art of how to prepare polyethylene waxes. Various types thereof are commercially available, also in the form of aqueous dispersions. Exemplarily, they can be prepared by thermal and, if appropriate, free-radical degradation of a higher molecular weight polyethylene or else by polymerization of ethylene, either by a free radical mechanism or by means of a transition metal catalyst.

The polyethylene wax optionally has a certain degree of branching which can also result, in the case of short chain branching, from the use of olefinic comonomers such as propene, 1-butene or 1-hexene.

To produce a dispersion which is suitable for the present invention, it is preferred to use, as starting material, partially oxidized polyethylene wax which may, if desired, have been additionally esterified and/or saponified. Many types of such polyethylene waxes are commercially available. In addition, it is possible to use copolymers which comprise 50 mol-% or more of ethylene and 50 mol-% or less of a polar monomer, for example ethylene-vinyl acetate copolymer waxes or copolymers of ethylene and acrylic acid. Another possible way of preparing dispersible polyethylene is to graft polyethylene in the melt with an unsaturated polar monomer, for example with maleic anhydride. For this purpose, it is generally useful to add a free-radical initiator.

The polyethylene wax which has been modified in this way can, if desired after further modification, be converted by customary methods into a nonionic, anionic or cationic dispersion, usually with addition of one or more emulsifiers.

There are many commercially available (partial) fatty acid esters that can used as the at least one gliding agent, preferably the so-called ester waxes. Preferable examples include stearic acid esters of ethylene glycol, diethylene glycol, polyethylene glycol or 1,4-butanediol or glyceryl tristearate and also mixed partial esters of mannitol with stearic acid and palmitic acid.

Suitable fatty acids as the at least one gliding agent have the structure Rx-COOH, where Rx is a C10-C22-alkyl or C10-C22-alkenyl group. Preferable examples are oleic acid, stearic acid, palmitic acid and lauric acid.

It is possible within the context of the present invention that a mixture of gliding agents is employed. For instance, a wax and a fatty acid or wax and a (partial) fatty acid ester or a fatty acid and a (partial) fatty acid ester or any other combination can be used.

The additive formulation optionally comprises at least one solvent, the at least one solvent being preferably selected from the group consisting of water, organic solvent and mixtures thereof. The organic solvent described hereinbefore may be used if desired. More preferably, the at least one solvent is water for its ecologically benign character.

The amount of the at least one gliding agent in the additive formulation preferably ranges 0.05 from to 5 weight-%, more preferably from 0.1 to 2 weight-%, based on the additive formulation. In case more than one gliding agent is used in the additive formulation, the total amount of all gliding agents preferably lies in above ranges.

Generally, and especially in case the additive formulation is a dispersion (e.g., an emulsion), the additive formulation preferably comprises at least one emulsifier (also referred to as surfactant or wetting agent in the art). The at least one emulsifier and its amount can be selected based on the general knowledge of the person skilled in the art and routine experiments. The at least one emulsifier is preferably contained in the additive formulation in an amount of 0.01 to 10 wt.-%, more preferably 0.1 to 2.5 wt.-%, even more preferably 0.2 to 1.0 wt.-%, based on the total additive formulation. If more than one emulsifier is contained, the overall amount of all emulsifiers preferably lies in above-defined ranges. Preferably, the at least one emulsifier has a HLB value of 8 or above, more preferably of 11 or above.

Useful emulsifiers are selected from the group consisting of non-ionic, anionic, cationic, amphoteric emulsifiers and mixtures of the aforementioned. The at least one emulsifier is preferably selected from the group consisting of non-ionic, anionic, cationic emulsifiers and mixtures of the aforementioned, more preferably selected from the group consisting of non-ionic and cationic emulsifiers and mixtures of the aforementioned.

Preferable examples for non-ionic emulsifiers are represented by formula (E):

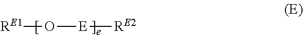

wherein
R^{E1} is a C8-C22-alkyl group;
R^{E2} is selected from the group consisting of hydrogen, alkyl group, hydroxyl group and oxyalkyl group;
each E independently is an alkanediyl group; and
e is an integer ranging from 1 to 100.

R^{E1} is preferably a C10-C18-alkyl group, more preferably a C12-C16-alkyl group. Preferably, R^{E1} is a branched alkyl group. Most preferably, R^{E1} is an iso-C3-alkyl group. R^{E2} is preferably selected from the group consisting of, hydroxyl group, oxymethyl group and methyl group. More preferably, R^{E2} is a hydroxyl group. E is preferably selected from the group consisting of 1,2-ethanediyl group, 1,2-propanediyl group and 1,3-propanediyl group. e preferably ranges from 2 to 10, preferably from 3 to 7, more preferably from 4 to 6.

Preferably, the anionic emulsifier is represented by formula (L)

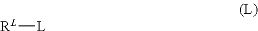

wherein
R^{L} is a C8-C22-alkyl group; and
L is selected from the group consisting of carboxylic acid group (—CO₂H), sulfonic acid group (—SO₃H) and phosphonic acid group (—PO₃H₂) or a salt thereof.
R^{L} is preferably a C10-C18-alkyl group, more preferably a C12-C16-alkyl group. Preferably, R^{L} is a branched alkyl group. L is preferably a sulfonic acid group or a salt thereof.

A cationic emulsifier is preferably represented by formula (T)

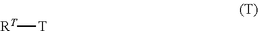

wherein
R^{T} is a C8-C22-alkyl group; and
T is a cationic group, preferably a —NR^{k}₄⁺ group with R^{k} being hydrogen or an alkyl group (which is preferred) such as methyl group or ethyl group. R^{T} is preferably a C10-C18-alkyl group, more preferably a C12-C16-alkyl group.

Preferably, the additive formulation comprises colloidal silica, preferably in an amount ranging from 0.01 to 1 weight-%, preferably from 0.05 to 0.5 weight-%, more preferably from 0.1 to 0.25 weight-%, based on the total weight of the additive formulation (and the solids content of the colloidal silica if a dispersion is used). The size (d₅₀) of the silica particles preferably ranges from 10 to 250, more preferably 20 to 100 nm. The d₅₀ value can be measured by dynamic light scattering using preferably a Malvern Panalytical in accordance with ISO 22412:2017-02. The colloidal silica may improve the stability of the additive formulation.

Optionally, the additive formulation comprises an organic polymer selected from the group consisting of polyurethane, polyesters, polymethacrylates and mixtures and copolymers of the aforementioned. The amount of the organic polymer preferably ranges from 0.01 to 10 weight-%, preferably from 0.1 to 5 weight-%, more preferably from 0.25 to 1 weight-%, based on the additive formulation. The organic polymer enhances the adhesion of labels, paints or inks applied to the surface after applying the additive formulation.

The at least one glass surface is treated with the silane formulation and the additive formulation by common means. Preferably, the treatments of the at least one glass surface in method steps b) and c) are independently performed by means of spraying, dipping, rolling, painting and combinations of the aforementioned. Preference is given to spraying in both method steps.

The temperature of the at least one glass surface in method steps c) independently preferably ranges from 20 to 200° C., more preferably from 60 to 150° C., even more preferably from 100 or 110 to 130° C.

Optionally, the temperature of the additive formulation is adjusted to a value ranging from 10 to 80° C., preferably 20 to 30° C., prior to it being used for the treating the at least one glass surface therewith.

Preferably, the inventive method does not employ any tin compounds such as tin salts like n-butyltin trichloride and tin tetrachloride. Therefore, the silane formulation is preferably free of (intentionally added) tin compounds. Further, the additive formulation is preferably free of (intentionally added) tin compounds. This means that the content of tin compounds in the silane formulation and in the additive formulation is preferably 0.1 weight-% or less, more preferably 0.01 weight-% or less, even more preferably 0.001 weight-%, they ideally are completely free of tin compounds. Particularly, the inventive method does not employ any tin compounds to bind the at least one gliding agent to the at least one glass surface. The omission of tin compounds such as tin salts is environmentally and toxicologically advantageous as already outlined hereinbefore.

In another aspect of the present invention, the silane formulation is used as adhesion promotor for the at least one gliding agent, the at least one gliding agent being preferably selected from the group consisting of wax, fatty acid and fatty acid ester, on a glass surface of a substrate, especially in a cold-end coating process.

In still another aspect, the present invention further is directed at a substrate comprising
i) at least one glass surface;
ii) at least one silane based layer obtained by treating the at least one glass surface with a silane formulation as defined hereinbefore (hereinafter “layer ii)”);
iii) at least one additive layer comprising the at least one gliding agent selected from the group consisting of wax, fatty acid, fatty acid ester and wetting agent on the silane based layer (hereinafter “layer iii)”).

Layer ii) is obtained by treating the at least one glass surface with the silane formulation as defined hereinbefore. The layer ii) proved difficult to characterize. It is believed by the inventors of the present invention that a multitude of compounds derived from the at least one bis-silyl compound are present in layer ii). Layer iii) is obtained by treatment of the at least one glass surface (after the formation of layer ii) thereon) with the additive formulation.

The substrate optionally comprises one or more than one further layers to be located underneath (i.e. between layer ii) and the at least one glass surface), on top of or between the layers ii) and iii). Preferably, the optional further layer is located on top of layer iii). The layers ii) and iii) are arranged preferably directly on each other. Layer ii) is preferably arranged directly on the at least one glass surface. Layer ii) is present on the entire glass surface or only on one or more parts thereof. Layer iii) is present on the entire surface area of layer ii) or only on one or more parts thereof. Optionally, the substrate comprises one or more adhesive layers on layer iii). Conventionally used adhesives can be used for this purpose without limitation. On the optional adhesive layer a label is optionally located. The label is usually made of paper or the like and may be printed on the outer side.

Preferably, the substrate is a hollow container, more preferably a hollow container selected from the group consisting of bottle, thermos, ampule, tube, jar, vial and flask.

In still another aspect of the present invention, the substrate, especially the hollow container as the substrate, according to the invention is used to store a fluid or a solid, preferably a fluid, more preferably a liquid, even more preferably a beverage such as water therein.

In yet another aspect, the present invention concerns a kit-of-parts, said kit-of-parts comprises: P1) a pre-silane formulation comprising at least one bis-silyl compound comprising at least one building block according to formula (A)

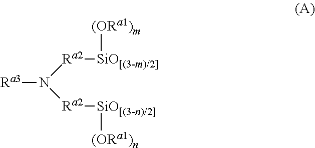

wherein
each R^{a1} is independently selected from the group consisting of hydrogen, alkyl group and aryl group,
each R^{a2} is independently an alkanediyl group,
R^{a3} is selected from the group consisting of hydrogen, alkyl group and aryl group,
m is an integer ranging from 0 to 3,
n is an integer ranging from 0 to 3; and

P2) a pre-additive formulation comprising at least one gliding agent selected from the group consisting of wax, fatty acid and fatty acid ester.

P1 preferably comprises the at least one bis-silyl compound, the at least one silane-based compound, the at least one acid and water.

The pre-silane formulation can be identical to the silane formulation described hereinbefore. It is preferred however, that it is more concentrated. Therefore, the amounts of the at least one bis-silyl compound and the at least one optional acid are preferably higher while the amounts of the solvents (if any)—i.e. the at least one organic solvent and water—are lower compared to the silane formulation to save shipping costs. To that end, the amount of the at least one bis-silyl compound in the pre-silane formulation preferably ranges from 5 weight-% to 25 weight-%, more preferably from 10 to 20 weight-%.

The amount of the at least one acid in the pre-silane formulation is preferably at least 0.1 weight-%, more preferably 0.15 weight-%, even more preferably 0.2 weight-%.

The pre-additive formulation can be identical to the additive formulation described hereinbefore. It is preferred however, that the amount of the at least one gliding agent is higher while the amounts of the solvents (if any)—the at least one organic solvent and water—are lower to save shipping costs. The amount of the at least one gliding agent in the pre-additive formulation preferably ranges from 10 to 50 weight-%, preferably from 15 to 40 weight-%, more preferably from 20 to 30 weight-%.

The pre-silane formulation and the pre-additive formulation can be diluted, for example with water and/or at least one organic solvent, preferably with water, to the desired concentrations prior to use.

The invention will now be illustrated by reference to the following non-limiting examples.

### EXAMPLES

Commercial products were used as described in the technical datasheet available on the date of filing of this specification unless stated otherwise hereinafter. The most recent version of standards was used unless stated differently hereinafter.

As glass substrates untreated 1 l soda lime silicate glass bottles were used in all experiments. As hand applicator, a spray gun (IPOTOOLS Mini HLVP Spray Gun) was used. A polyethylene dispersion obtained from TotalEnergies and is available as Glasskote SC100 E was used to prepare the additive formulation in the examples.

Determination of Dry Residue (Solids content): The solids content (also referred to as dry residue) of the formulations was determined as follows: 1.000 g of the sample was weighed out into a small porcelain dish and dried until weight constancy in a drying oven at 105° C.

### Determination of the Amine Content

150-400 mg sample (depending on the amine content) were weighed into an 150 ml beaker and dissolved with 90 ml acid (conc.). The resulting solution was titrated with perchloric acid-solution in acetic acid (c(HClO₄)=0.1 Mol/l with potentographic detection. The factor of the perchloric acid solution was determined with potassium hydrogenphtalate.

### Calculation:

$${NH}_{2} [ \% ] = \frac{100 * V * c * f * 16.02}{E}$$

V=mL perchloric acid
c=concentration of perchloric acid in mol/I
f=factor of perchloric acid
E=sample quantity in g

### Determination of Free Alcohol Content in the Silane Formulation:

The alcohol determination was carried out by means of gas chromatography (Column: RTX 200 (60 m), Temperature program: 90° C. for 10 min-25° C./min to 240° C., Detector: FID, Injection volume: 1.0 μl, internal standard: 2-butanol).

The pH value was measured in accordance to DIN EN ISO 10523 (2012).

The viscosity was measured in accordance to DIN 53015 (2019).

### Comparative Example 1

A reactor was charged with 80.0 g of water under nitrogen atmosphere. 20.0 g (3-aminopropyl)triethoxysilane were added thereto. The reaction mixture was stirred for 3 hours at 60° C. until the silane was fully hydrolyzed. The thus obtained formulation comprising a silane oligomer formed a clear colorless liquid and had the following analytical and physical data:
Solids content: 7.4 weight-%
Free ethanol content: 13 weight-%
Amine content as NH₂: 1.5 weight-%
Viscosity: 3.0 mPas
pH: 11.0

### Comparative Example 2

Comparative example 1 was repeated using 80 g of an aqueous solution containing 5.4 g of a 85 weight-% formic acid instead of water. The thus obtained formulation comprising a silane oligomer formed a clear colorless liquid and had the following analytical and physical data:
Solids content: 12 weight-%
Free ethanol content: 13 weight-%
Amine content as NH₂: 1.48 weight-%
Viscosity: 2.9 mPas
pH: 4.5

### Comparative Example 3

Comparative example 1 was repeated using 20 g (3-Aminopropyl)dimethoxymethylsilane instead of the aforementioned silane. The thus obtained formulation comprising a silane oligomer formed a clear colorless liquid and had the following analytical and physical data:
Solids content: 14.4 weight-%
Free methanol: 7.9 weight-%
Amine content as NH₂: 1.97 weight-%
Viscosity: 3 mPas
pH: 11.2

### Preparation Example 1

A reactor was charged with 80 g of an aqueous solution containing 5.4 g of a 85 weight-% formic acid (aqueous solution thereof, aq.) under nitrogen atmosphere. 19.8 g (3-aminopropyl)triethoxysilane and 0.2 g bis[3-(triethoxysilyl)propyl]amine were added to said solution. The reaction mixture was stirred for 3 hours at 60° C. until the silane was fully hydrolyzed. The thus obtained formulation comprising a bis-silyl compound formed a clear colorless liquid and had the following analytical and physical data:
Solids content: 12.1 weight-%
Free ethanol content: 13.0%
Amine content as NH₂: 1.48%
Viscosity: 2.9 mPas
pH: 4.5

### Preparation Example 2

Preparation example 1 was repeated using 19.0 g (3-aminopropyl)triethoxysilane and 1.0 g bis[3-(triethoxysilyl)propyl]amine and 80 g of a aqueous solution containing 5.0 g of a 85 weight-% formic acid (aq.). The thus obtained formulation comprising a bis-silyl compound forms a clear colorless liquid and had the following analytical and physical data:
Solids content: 12.0 weight-%
Free ethanol content: 13%
Amine content as NH₂: 1.44%
Viscosity: 2.9 mPas
pH: 4.7

### Preparation Example 3

Preparation example 1 was repeated using 18.0 g (3-aminopropyl)triethoxysilane and 2.0 g bis[3-(triethoxysilyl)propyl]amine and 80 g of a aqueous solution containing 5.1 g of a 85 weight-% formic acid (aq.). The thus obtained formulation comprising a bis-silyl compound forms a clear colorless liquid and had the following analytical and physical data:
Solids content: 12.3 weight-%
Free ethanol content: 12%
Amine content as NH₂: 1.4%
Viscosity: 3.0 mPas
pH: 4.4

### Preparation Example 4

Preparation example 1 was repeated using 16.0 g (3-aminopropyl)triethoxysilane and 4.0 g bis[3-(triethoxysilyl)propyl]amine and 80 g of a aqueous solution containing 5.1 g of a 85 weight-% formic acid (aq.). The thus obtained formulation comprising a bis-silyl compound forms a clear colorless liquid and had the following analytical and physical data:
Solids content: 12.1 weight-%
Free ethanol content: 12%
Amine content as NH₂: 1.3%
Viscosity: 3.2 mPas
pH: 4.2

### Preparation Example 5

Preparation example 1 was repeated using 7.5 g (3-aminopropyl)triethoxysilane and 7.5 g bis[3-(triethoxysilyl)propyl]amine and 85 g of a aqueous solution containing 3.9 g of a 85 weight-% formic acid (aq.). The thus obtained formulation comprising a bis-silyl compound forms a clear colorless liquid and had the following analytical and physical data:
Solids content: 10.7 weight-%
Free ethanol content: 9.4%
Amine content as NH₂: 0.84%
Viscosity: 2.8 mPas
pH: 3.9

### Preparation Example 6 (100% Building Blocks According to Formula (A))

A reactor was charged with 85 g of an aqueous solution containing 2.0 g of a 85 weight-% formic acid (aq.) under nitrogen atmosphere. 15.0 g bis[3-(triethoxysilyl)propyl]amine was added to said solution. The reaction mixture was stirred for 3 hours at 60° C. until the silane was fully hydrolyzed. The thus obtained formulation comprising a bis-silyl compound formed a clear colorless liquid and had the following analytical and physical data:
Solids content: 8.6 weight-%
Free ethanol content: 9.5%
Amine content as NH₂: 0.6%
Viscosity: 12.6 mPas
pH: 4.5

### Application of the Silane Formulations (Corresponds to Method Step b))

The product mixtures obtained as described in preparation examples 1 to 6 were diluted with deionized water in the ratios given in the tables below (denominated below as “dilution factor”). By that, the silane formulation was prepared and ready to use.

Analogously, comparative formulations with silane oligomer were obtained by diluting the product mixtures obtained as comparative examples 1 to 3 with DI water in the ratios given in the following table (denominated below as “dilution factor”).

The glass substrates were treated by spray coating with a hand applicator. To that end, the bottle was rotated once while the entire surface of the bottle was treated. The bottles were heated in an oven to the temperatures given in tables 1 and 2 below prior to the described treatment. The spray conditions were:
Nozzle diameter: 0.5 mm
Application pressure: 4 bar
Spray distance: 20 cm
Spray amount: 20 ml/min
rotation duration about 6-7 seconds

### Application of the Additive Formulations (Corresponds to Method Step c))

The glass substrates were coated by spray coating with a hand applicator. To that end, the bottle was rotated twice while the entire surface of the bottle was treated. The bottles were heated in an oven to the temperatures given below prior to the described treatment. The additive formulation was prepared by diluting Glasskote SC100 E with deionized water to the concentration given below. The spray conditions were:
Temperature: 90° C.
Polyethylene concentration: 0.28 wt.-%
Nozzle diameter: 0.8 mm
Application pressure: 4 bar
Spray distance: 20 cm
Spray amount: 20 ml/min
rotation duration each about 10 seconds

### Tests Methods

### Dry and Wet Scratch Resistance—Scratch Test

The scratch resistance was tested by rubbing the surfaces of two coated glass bottles against each other, one bottle in each hand. The test was repeated several times at various areas of the glass bottles by at least two individuals. Instances of scratching or sliding resistance were recorded. The wet scratch resistance was tested in the same way as the dry scratch resistance but with a glass surface wetted with water beforehand. To that end, the glass surface was wetted under running water (until wetted). The pressure and scratch time (15 s) were kept constant.

Ranking: no scratches: 1, slight scratches: 2, scratches over entire test surface: 3

### Optical Appearance

The optical appearance was visually inspected by at least two individuals. The optical appearance was ranked via the turbidity with the following criteria: clear (1), slightly turbid (2) and turbid (3).

### Adhesion of the Labels

Paper labels using standard adhesives (Turmerleim ST 50 KF, a standard casein-based label adhesive) were glued onto the treated glass bottles. The paper labels were cured for 7 days at room temperature (20° C.). The labels were peeled off manually.

The ranking was as follows: no peeling (fiber tear)=1 (good), partial peeling=2 (acceptable) and full peeling=3 (not acceptable).

TABLE 1
Test Results for a silane formulation comprising a bis-silyl compound and
a comparative formulation comprising a silane oligomer, respectively.

| | Dilution | Bottle | Dry scratch | Wet scratch | Optical | Adhesion |
|---|---|---|---|---|---|---|
| | factor* | temperature | resistance | resistance | appearance | of labels |
| Comparative | 1:80 | 130 | 1 | 3 | 1 | 1 |
| example 1^{a} | | | | | | |
| Comparative | 1:80 | 130 | 2 | 3 | 1 | 1 |
| example 2^{a} | | | | | | |
| Comparative | 1:80 | 130 | 1 | 3 | 1 | 2 |
| example 3^{a} | | | | | | |
| Preparation | 1:80 | 130 | 1 | 2 | 1 | 1 |
| Example 1^{b} | | | | | | |
| Preparation | 1:80 | 130 | 1 | 1 | 1 | 1 |
| Example 2^{b} | | | | | | |
| Preparation | 1:80 | 130 | 1 | 1 | 1 | 1 |
| Example 3^{b} | | | | | | |
| Preparation | 1:80 | 130 | 1 | 1 | 1 | 1 |
| Example 4^{b} | | | | | | |
| Preparation | 1:60 | 130 | 1 | 1 | 1 | 1 |
| Example 5^{b} | | | | | | |
| Preparation | 1:60 | 130 | 1 | 3 | 1 | 1 |
| Example 6^{b} | | | | | | |

^{a}comparative example;
^{b}example according to the invention;
*parts per weight of the preparation examples/comparative example to parts per weight of water (1:40 means for example 1 g of the preparation example is diluted with 40 g of water)

TABLE 2
Test Results for a silane formulation a bis-silyl compound
and a comparative formulation comprising a silane oligomer,
respectively, in higher concentrations compared to table 1.

| | Dilution | Bottle | Dry scratch | Wet scratch | Optical | Adhesion |
|---|---|---|---|---|---|---|
| | factor* | temperature | resistance | resistance | appearance | of labels |
| Comparative | 1:40 | 130 | 2 | 3 | 1 | 2 |
| example 1^{a} | | | | | | |
| Comparative | 1:40 | 130 | 2 | 3 | 1 | 2 |
| example 2^{a} | | | | | | |
| Comparative | 1:40 | 130 | 3 | 3 | 1 | 3 |
| example 3^{a} | | | | | | |
| Preparation | 1:40 | 130 | 2 | 3 | 1 | 1 |
| Example 1^{b} | | | | | | |
| Preparation | 1:40 | 130 | 2 | 3 | 1 | 1 |
| Example 2^{b} | | | | | | |
| Preparation | 1:40 | 130 | 1 | 2 | 1 | 1 |
| Example 3^{b} | | | | | | |
| Preparation | 1:40 | 130 | 1 | 1 | 1 | 1 |
| Example 4^{b} | | | | | | |
| Preparation | 1:30 | 130 | 1 | 1 | 1 | 1 |
| Example 5^{b} | | | | | | |
| Preparation | 1:30 | 130 | 1 | 3 | 1 | 2 |
| Example 6^{b} | | | | | | |

^{a}comparative example;
^{b}example according to the invention

The results show clearly that the method according to the invention improves the scratch resistance of glass surfaces treated accordingly compared to glass bottles treated by prior art methods. In particular, the wet scratch resistance was significantly enhanced.

In addition, the adhesion of the labels was excellent in case of the inventive examples and mostly better than those of the comparative examples (see in particular the results given in table 2). It is also advantageous that no properties of the bottles were impaired such as their optical appearance or their (basic) strength.

Other embodiments of the present invention will be apparent to those skilled in the art from a consideration of this specification or practice of the invention disclosed herein. It is intended that the specification and examples be considered as exemplary only, with the true scope of the invention being defined by the following claims only.

1. A method for treating at least one glass surface, the method comprising:
a) providing a substrate comprising the at least one glass surface;
b) treating the at least one glass surface with a silane formulation comprising at least one bis-silyl compound comprising at least one building block according to the following formula (A): 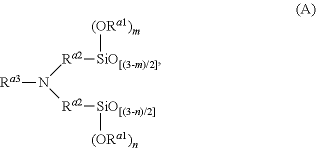
wherein
each R^{a1} is independently selected from the group consisting of hydrogen, alkyl group, polyether group and aryl group,
each R^{a2} is independently an alkanediyl group,
R^{a3} is selected from the group consisting of hydrogen, alkyl group and aryl group,
m is an integer ranging from 0 to 3,
n is an integer ranging from 0 to 3; and
c) treating the at least one glass surface with an additive formulation comprising at least one gliding agent selected from the group consisting of wax, fatty acid and fatty acid ester;
such that the at least one treated glass surface is obtained.

2. The method according to claim 1, wherein the bis-silyl compound comprises at least one building block according to the following formula (B); 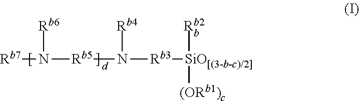
wherein
each R^{b1} is independently selected from the group consisting of hydrogen, alkyl group and aryl group,
R^{b2} is an alkyl group,
R^{b3} is an alkanediyl group,
R^{b4} is selected from the group consisting of hydrogen, alkyl group, aryl group and alkaryl group,
each R^{b5} is independently an alkanediyl group,
R^{b6} is selected from the group consisting of hydrogen, alkyl group, aryl group and alkaryl group,
R^{b7} is selected from the group consisting of hydrogen and alkyl group,
b is selected from 0 and 1,
c is selected from 0, 1 and 2,
d is selected from 0, 1 and 2,
with the proviso that the sum of b and c ranges from 0 to 2.

3. The method according to claim 1, wherein the silane formulation comprises at least one acid.

4. The method according to claim 1, wherein the silane formulation comprises water.

5. The method according to claim 2, wherein the numerical ratio of the at least one building block according to the formula (A) and the at least one building block according to the formula (B) in the bis-silyl compound is from 1:1 to 1:250.

6. The method according to claim 1, wherein the method does not use tin compounds.

7. The method according to claim 1, wherein R^{a1} is selected from the group consisting of hydrogen and C1-C4-alkyl group, R^{a2} is a C2-C4-alkandiyl group and R^{a3} is selected from the group consisting of hydrogen and C1-C4-alkyl group.

8. The method according to claim 1, wherein an amount of the at least one bis-silyl compound in the silane formulation is from 0.001 to 10 weight %, based on the total silane formulation.

9. The method according to claim 1, wherein the at least one gliding agent is a wax.

10. The method according to claim 1, wherein the silane formulation comprises at least one silane-based compound comprising at least one building block according to the following formula (I) 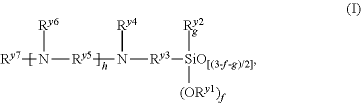
wherein
each R^{y1} is independently selected from the group consisting of hydrogen, alkyl group, polyether group and aryl group,
R^{y2} is an alkyl group,
R^{y3} is an alkanediyl group,
R^{y4} is selected from the group consisting of hydrogen, alkyl group, aryl group and alkaryl group,
each R^{y5} is independently an alkanediyl group,
R^{y6} is selected from the group consisting of hydrogen, alkyl group, aryl group and alkaryl group,
R^{y7} is selected from the group consisting of hydrogen and alkyl group,
f is selected from 0, 1 and 2
g is selected from 0 and 1,
h is selected from 0, 1 and 2,
with the proviso that the sum of f and g preferably ranges from 0 to 2.

11. A method comprising applying an adhesion promotor for a gliding agent selected from the group consisting of wax, fatty acid and fatty acid ester, on a glass surface of a substrate,
wherein the adhesion promotor comprises at least one bis-silyl compound comprising at least one building block according to the following formula (A); 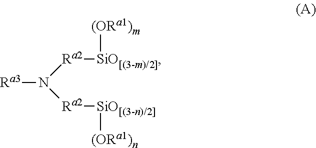
wherein
each R^{a1} is independently selected from the group consisting of hydrogen, alkyl:
group and aryl group,
each R^{a2} is independently an alkanediyl group,
R^{a3} is selected from the group consisting of hydrogen, alkyl group and aryl group,
m is an integer ranging from 0 to 3,
n is an integer ranging from 0 to 3.

12. A substrate comprising:
i) at least one glass surface;
ii) at least one silane based layer obtained by treating the at least one glass surface with a silane formulation, wherein the silane formulation comprises at least one bis-silyl compound comprising at least one building block according to the following formula (A): 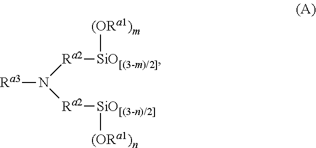
wherein
each R^{a1} is independently selected from the group consisting of hydrogen, alkyl group, polyether group and aryl group,
each R^{a} is independently an alkanediyl group,
R^{a3} is selected from the group consisting of hydrogen, alkyl group and aryl group,
m is an integer ranging from 0 to 3,
n is an integer ranging from 0 to 3; and
iii) at least one additive layer comprising the at least one gliding agent selected from the group consisting of wax, fatty acid and fatty acid ester on the silane based layer.

13. The substrate according to claim 12, wherein the substrate is a hollow container.

14. (canceled)

15. A kit comprising:
P1) a pre-silane formulation comprising at least one bis-silyl compound comprising at least one building block according to the following formula (A) 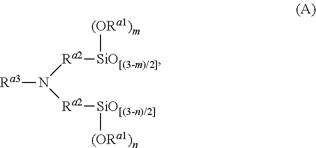
wherein
each R^{a1} is independently selected from the group consisting of hydrogen, alkyl group:
and aryl group,
each R^{a2} is independently an alkanediyl group,
R^{a3} is selected from the group consisting of hydrogen, alkyl group and aryl group,
m is an integer ranging from 0 to 3,
n is an integer ranging from 0 to 3; and
P2) an pre-additive formulation comprising at least one gliding agent selected from the group consisting of wax, fatty acid and fatty acid ester.

16. The method according to claim 8, wherein the amount of the at least one bis-silyl compound in the silane formulation is from 0.01 to 4 weight %, based on the total silane formulation.

17. The method according to claim 8, wherein the amount of the at least one bis-silyl compound in the silane formulation is from 0.05 to 1 weight %, based on the total silane formulation.

18. The method according to claim 9, wherein the at least one gliding agent is an amide wax, a polyolefin wax, a copolymer of a polyolefin wax, or a combination thereof.
